(19) United States
(12) Patent Application Publication
(10) Pub. No.: US 2002/0073570 A1
(43) Pub. Date: Jun. 20, 2002

(54) End hook of a tape measure

(76) Inventor: Corey P. Conder, Lehi, UT (US)

Correspondence Address: Kaardal & Associates, PC, Attn: Ivar M. Kaardal, Suite 250, 3500 South First Ave. Circle, Sioux Falls, SD, 57105-5807, US

(21) Appl. No.: 09/737,785

(22) Filed: Dec. 15, 2000

(51) Int. Cl. G01B 3/10

(52) U.S. Cl. 33/758; 33/755

(57) ABSTRACT

An end hook of a tape measure for permitting hooking of the tape measure to variously oriented objects while maintaining a readable orientation of the measuring tape. The end hook of the tape measure includes an end hook coupled to a tape measure, the end hook having an outer perimeter edge that protrudes orthogonally outward from all sides of the end of the measuring tape of the tape measure. In an embodiment, the end hook generally includes a disk shaped main member having a circular outer perimeter edge and a plurality of slots extending through the main member. In an embodiment, the end hook is designed for attachment to an existing tape measure.

### BACKGROUND OF THE INVENTION

1. Field of the Invention

The present invention relates to tape measures having end hooks and more particularly pertains to a new end hook of a tape measure for permitting hooking of the tape measure to variously oriented objects while maintaining a readable orientation of the measuring tape of the tape measure.

2. Description of the Prior Art

The use of tape measures having end hooks is known in the prior art. More specifically, tape measures having end hooks heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 4,288,923; U.S. Pat. No. 4,890,393; U.S. Pat. No. 4,305,206; U.S. Pat. No. 5,421,100; U.S. Pat. No. 5,172,486; and U.S. Pat. No. 4,603,481.

While these devices fulfill their respective, particular objectives and requirements, the aforementioned patents do not disclose a new end hook of a tape measure. The inventive device includes an end hook coupled to a tape measure, the end hook having an outer perimeter edge that protrudes orthogonally outward from all sides of the end of the measuring tape of the tape measure.

In these respects, the end hook of a tape measure according to the present invention substantially departs from the conventional concepts and designs of the prior art, and in so doing provides an apparatus primarily developed for the purpose of permitting hooking of the tape measure to variously oriented objects while maintaining a readable orientation of the measuring tape of the tape measure.

### SUMMARY OF THE INVENTION

In view of the foregoing disadvantages inherent in the known types of tape measures having end hooks now present in the prior art, the present invention provides a new end hook of a tape measure construction wherein the same can be utilized for permitting hooking of the tape measure to variously oriented objects while maintaining a readable orientation of the measuring tape of the tape measure.

The general purpose of the present invention, which will be described subsequently in greater detail, is to provide a new end hook of a tape measure apparatus and method which has many of the advantages of the tape measures having end hooks mentioned heretofore and many novel features that result in a new end hook of a tape measure which is not anticipated, rendered obvious, suggested, or even implied by any of the prior art tape measures having end hooks, either alone or in any combination thereof.

To attain this, the present invention generally comprises an end hook coupled to a tape measure, the end hook having an outer perimeter edge that protrudes orthogonally outward from all sides of the end of the measuring tape of the tape measure.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new end hook of a tape measure apparatus and method which has many of the advantages of the tape measures having end hooks mentioned heretofore and many novel features that result in a new end hook of a tape measure which is not anticipated, rendered obvious, suggested, or even implied by any of the prior art tape measures having end hooks, either alone or in any combination thereof.

It is another object of the present invention to provide a new end hook of a tape measure which may be easily and efficiently manufactured and marketed.

It is a further object of the present invention to provide a new end hook of a tape measure which is of a durable and reliable construction.

An even further object of the present invention is to provide a new end hook of a tape measure which is susceptible of a low cost of manufacture with regard to both materials and labor, and which accordingly is then susceptible of low prices of sale to the consuming public, thereby making such end hook of a tape measure economically available to the buying public.

Still yet another object of the present invention is to provide a new end hook of a tape measure which provides in the apparatuses and methods of the prior art some of the advantages thereof, while simultaneously overcoming some of the disadvantages normally associated therewith.

Still another object of the present invention is to provide a new end hook of a tape measure for permitting hooking of the tape measure to variously oriented objects while maintaining a readable orientation of the measuring tape of the tape measure.

Yet another object of the present invention is to provide a new end hook of a tape measure which includes an end hook coupled to a tape measure, the end hook having an outer perimeter edge that protrudes orthogonally outward from all sides of the end of the measuring tape of the tape measure.

Still yet another object of the present invention is to provide a new end hook of a tape measure that can be incorporated into a tape measure assembly at the time of manufacture or as an after market product attachable to an existing tape measure.

Even still another object of the present invention is to provide a new end hook of a tape measure that permits holding of the tape measure at various orientations when measuring a length of a surface.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a new end hook of a tape measure according to the present invention.

FIG. 2 is a perspective view of the present invention.

FIG. 3 is a cross-sectional view taken along line 3-3 of FIG. 2.

FIG. 4 is a perspective view of an embodiment of the present invention.

FIG. 5 is a cross-sectional view of the present invention taken along line 5-5 of FIG. 4.

### DESCRIPTION OF THE PREFERRED EMBODIMENT

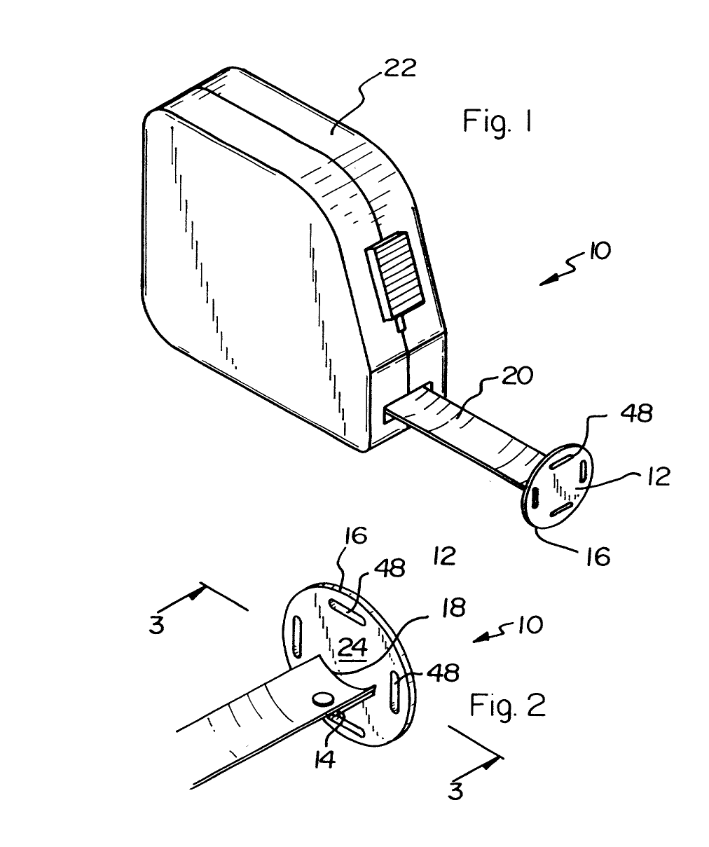

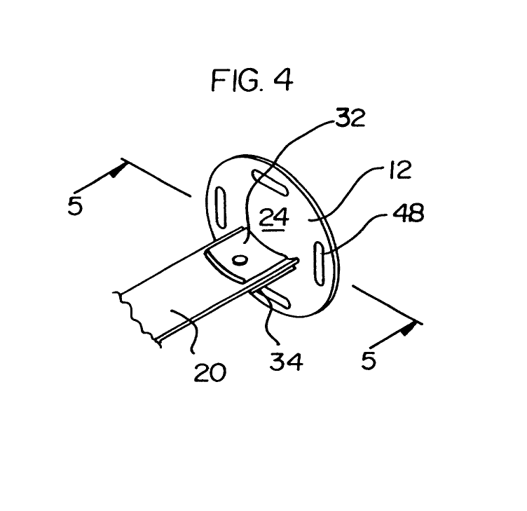

With reference now to the drawings, and in particular to FIGS. 1 through 5 thereof, a new end hook of a tape measure embodying the principles and concepts of the present invention and generally designated by the reference numeral 10 will be described.

As best illustrated in FIGS. 1 through 5, the end hook of a tape measure 10 generally comprises a hook member 12 having a connection portion 14 and an outer perimeter edge 16. The hook member is designed for coupling to an end 18 of a measuring tape 20 of a tape measure 22.

The connection portion extends outwardly from a first face 24 of the hook member. The connection portion is also designed for coupling to the end of the measuring tape such that a full length of the outer perimeter edge is positioned in spaced relationship to the end of the measuring tape. Thus, the outer perimeter edge is designed to engage an object during use of the tape measure while the measuring tape is positioned in a readable orientation.

The connection portion includes an upper protrusion 32 and a lower protrusion 34 positioned in spaced relationship with respect to each other. The upper and lower protrusions are designed for receiving the end of the tape measure therebetween. The upper protrusion includes an upper connection hole 33 extending through the upper protrusion and the lower protrusion includes a lower connection hole 35 aligned with the upper connection hole. The end of the measuring tape includes a tape hole 55 that is alignable with the holes 33 and 35.

A fastening member 38 is insertable through the upper connection hole, the lower connection hole and the tape hole when the end of the measuring tape is inserted between the upper and lower protrusions. Thus, the end of the measuring tape is engaged to the connection portion.

In an embodiment, the upper protrusion includes an arcuate lower surface 36 and the lower protrusion includes an arcuate upper surface 37 complimentary to the arcuate lower surface of the upper protrusion. Thus, the end of the measuring tape is held in an arcuate position when the end of the measuring tape is positioned in the connection portion for providing stiffness to the measuring tape to facilitate holding the measuring tape in a static position during use.

In an embodiment, the fastener is a threaded screw 42 and the lower connection hole is threaded for engaging the threaded screw.

The lower protrusion further includes a medial portion 44 and a pair of wing portions 46 extending outwardly from opposite sides of the medial portion. The lower connection hole is located in the medial portion and extends partially through the medial portion such that the lower protrusion has a continuous smooth lower surface 47 for preventing damage to an object to which the end hook is engaged.

The hook member is generally disk-shaped and the outer perimeter edge is generally circular. A plurality of slots 48 extend through the hook member. The slots are positioned in spaced relationship to each other and proximate the outer perimeter edge for facilitating coupling of the hook member to an object during use of the tape measure. In an embodiment, there are four slots. One pair positioned substantially perpendicular on opposite sides of the measuring tape, and another pair positioned substantially parallel on opposite sides of the measuring tape.

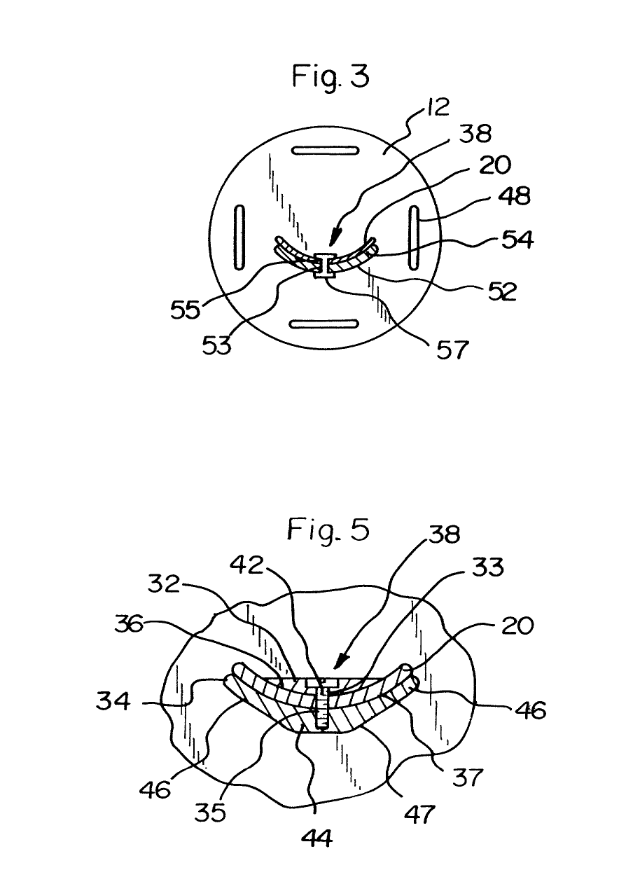

In another embodiment, the connection portion includes a single protrusion 52 having an aperture 53 extending therethrough. The fastening member is insertable through the aperture and is designed for coupling the single protrusion to the end of the measuring tape of the tape measure. The single protrusion includes an arcuate surface 54 designed for abutting the measuring tape. The surface is shown in FIG. 3 as the upper surface but may also be the lower surface with measuring tape abutting the lower surface. The arcuate surface 54 is designed for holding the end of the measuring tape in an arcuate position when the end of the measuring tape is coupled to the connection portion, thus facilitating maintenance of the measuring tape in a static position during use.

The fastener may be a pin 57 for economically coupling the end hook to a tape measure at the time of manufacture of the tape measure.

In use, the end hook permits holding of the tape measure in various orientations relative to the object being measured. Thus, the underside of objects can be measured while maintaining the readable surface of the measuring tape at a selectable orientation including facing upwardly or to either side relative to the measured surface.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An end hook for a tape measure, comprising:
a hook member having a connection portion and an outer perimeter edge, said hook member being adapted for coupling to an end of a measuring tape of a tape measure;
said connection portion extending outwardly from a first face of the hook member, the connection portion being adapted for coupling to the end of the measuring tape such that said hook member extends outwardly from the end of the measuring tape whereby a full length of said outer perimeter edge is positioned in spaced relationship to the end of the measuring tape such that said outer perimeter edge is adapted to engage an object during use of the tape measure while the measuring tape is positioned in a readable orientation.

2. The end hook for a tape measure of claim 1, further comprising:
said connection portion including an upper protrusion and a lower protrusion positioned in spaced relationship with respect to each other such that said upper and lower protrusions are adapted for receiving the end of the tape measure therebetween;
said upper protrusion having an upper connection hole extending through the upper protrusion;
said lower protrusion having a lower connection hole aligned with said upper connection hole; and
a fastening member being insertable through said upper connection hole and said lower connection hole when the end of the measuring tape is inserted between the upper and lower protrusions whereby the end of the measuring tape is engaged to the connection portion.

3. The end hook of claim 2, further comprising:
said upper protrusion having an arcuate lower surface and said lower protrusion having an arcuate upper surface complimentary to said arcuate lower surface of said upper protrusion whereby the end of the measuring tape is held in an arcuate position when the end of the measuring tape is positioned in the connection portion for facilitating maintenance of the measuring tape in a static position during use.

4. The end hook of claim 2, further comprising:
said fastener being a threaded screw; and
said lower connection hole being threaded for engaging said threaded screw.

5. The end hook of claim 2, further comprising:
said lower protrusion having a medial portion and a pair wing portions extending outwardly from opposite sides of the medial portion;
said lower connection hole being located in said medial portion and extending partially through said medial portion such that said lower protrusion includes a continuous smooth lower surface for preventing damage to an object to which the end hook is engaged.

6. The end hook of claim 1, further comprising:
said hook member being generally disk-shaped and said outer perimeter edge being generally circular.

7. The end hook of claim 1, further comprising:
a plurality of slots extending through said hook member, each of said slots being positioned in spaced relationship to each other proximate said outer perimeter edge for facilitating coupling of said hook member to an object during use of the tape measure.

8. The end hook of claim 1, further comprising:
said connection portion including a single protrusion having an aperture extending therethrough; and
a fastening member insertable through said aperture, said fastening member being adapted for coupling said single protrusion to the end of the measuring tape of the tape measure.

9. The end hook of claim 8, further comprising:
said single protrusion having an arcuate surface adapted for abutting the measuring tape for holding the end of the measuring tape in an arcuate position when the end of the measuring tape is coupled to the connection portion for facilitating maintenance of the measuring tape in a static position during use.

10. A tape measure assembly, comprising:
a tape measure having a measuring tape, the measuring tape having an end;
a hook member having a connection portion and an outer perimeter edge, said hook member being for coupling to said end of said measuring tape;
said connection portion extending outwardly from a first face of the hook member, the connection portion being for coupling to said end of said measuring tape such that said hook member extends outwardly from said end of said measuring tape whereby a full length of said outer perimeter edge is positioned in spaced relationship to said end of the measuring tape such that said outer perimeter edge is adapted to engage an object during use of said tape measure while said measuring tape is positioned in a readable orientation.

11. The end hook of claim 10, further comprising:
said connection portion including a single protrusion having an aperture extending therethrough;
said end of said measuring tape having a tape hole therein, said tape hole being alignable with said aperture; and
a fastening member insertable through said aperture and said tape hole, said fastening member being for coupling said single protrusion to said end of said measuring tape.

12. The end hook of claim 11, further comprising:
said single protrusion having an arcuate surface for abutting said measuring tape for holding said end of said measuring tape in an arcuate position when said end of said measuring tape is coupled to said connection portion for facilitating maintenance of said measuring tape in a static position during use.

13. An end hook for a tape measure, comprising:
a hook member having a connection portion and an outer perimeter edge, said hook member being adapted for coupling to an end of a measuring tape of a tape measure;
said connection portion extending outwardly from a first face of the hook member, the connection portion being adapted for coupling to the end of the measuring tape such that said hook member extends outwardly from the end of the measuring tape whereby a full length of said outer perimeter edge is positioned in spaced relationship to the end of the measuring tape such that said outer perimeter edge is adapted to engage an object during use of the tape measure while the measuring tape is positioned in a readable orientation;
said connection portion including an upper protrusion and a lower protrusion positioned in spaced relationship with respect to each other such that said upper and lower protrusions are adapted for receiving the end of the tape measure therebetween;
said upper protrusion having an upper connection hole extending through the upper protrusion;
said lower protrusion having a lower connection hole aligned with said upper connection hole;
a fastening member being insertable through said upper connection hole and said lower connection hole when the end of the measuring tape is inserted between the upper and lower protrusions whereby the end of the measuring tape is engaged to the connection portion;
said upper protrusion having an arcuate lower surface and said lower protrusion having an arcuate upper surface complimentary to said arcuate lower surface of said upper protrusion whereby the end of the measuring tape is held in an arcuate position when the end of the measuring tape is positioned in the connection portion for facilitating maintenance of the measuring tape in a static position during use;
said fastener being a threaded screw;
said lower connection hole being threaded for engaging said threaded screw;
said lower protrusion having a medial portion and a pair wing portions extending outwardly from opposite sides of the medial portion;
said lower connection hole being located in said medial portion and extending partially through said medial portion such that said lower protrusion includes a continuous smooth lower surface for preventing damage to an object to which the end hook is engaged;
said hook member being generally disk-shaped and said outer perimeter edge being generally circular; and
a plurality of slots extending through said hook member, each of said slots being positioned in spaced relationship to each other proximate said outer perimeter edge for facilitating coupling of said hook member to an object during use of the tape measure.
